(19) United States
(12) Patent Application Publication
(10) Pub. No.: US 2016/0325735 A1
(43) Pub. Date: Nov. 10, 2016

(54) CONTROL SYSTEM FOR POWER TRANSMISSION UNIT

(71) Applicant: TOYOTA JIDOSHA KABUSHIKI KAISHA, Toyota-shi (JP)

(72) Inventors: Shunya KATO, Toyota-shi, Aichi-ken (JP); Yosuke TAGAWA, Toyota-shi, Aichi-ken (JP); Tatsuya IMAMURA, Toyota-shi, Aichi-ken (JP); Atsushi TABATA, Toyota-shi, Aichi-ken (JP)

(73) Assignee: TOYOTA JIDOSHA KABUSHIKI KAISHA, Toyota-shi (JP)

(21) Appl. No.: 15/107,761

(22) PCT Filed: Sep. 16, 2014
(86) PCT No.: PCT/JP2014/074981

§ 371 Date: Jun. 23, 2016

(30) Foreign Application Priority Data
Dec. 25, 2013 (JP) 2013-266597

(51) Int. Cl. B60W 20/40; F02N 15/02; B60K 6/365; B60K 6/445; F16H 37/08; B60W 10/02

(52) U.S. Cl. CPC B60W 20/40; F16H 37/0833; B60W 10/02; B60K 6/365; B60K 6/445; F02N 15/025; B60K 2006/268

(57) ABSTRACT

A control system for a power transmission unit to start an engine by a motor even if one of the engagement elements cannot be engaged or disengaged. If a rotational speed of the engine cannot be raised to a predetermined speed during motoring even if sending out an initial command for disengaging one of the engagement elements while engaging other engagement element, the control system sends out an alternate command for engaging said one of the engagement elements while disengaging said other engagement element to bring the engine into an allowable condition to be started.

### TECHNICAL FIELD

This invention relates to a control system for a power transmission unit, and more particularly, to a control system for controlling a transmission having at least two engagement elements for shifting a gear stage that is connected to an output shaft of an engine.

### BACKGROUND ART

An example of a power transmission unit of this kind is described in Japanese Patent Laid-Open No. 2011-255889. The hybrid drive system taught by Japanese Patent Laid-Open No. 2011-255889 is comprised of a transmission adapted to shift a gear stage between a low speed stage and a high speed stage, a switching mechanism for shifting the gear stage, a power distribution mechanism for distributing a torque of the transmission to a first motor and to an output shaft, and a second motor disposed on the output shaft. An electric power generated by the first motor is supplied to the second motor, and a torque of the second motor is applied to the output shaft. A double-pinion type planetary gear unit is used as the transmission. In the planetary gear unit, a ring gear is connected with the engine to serve as an input element, a carrier serves as an output element to deliver the torque to the power distribution mechanism, and a sun gear can be selectively connected with the ring gear through the switching mechanism or fixed to a casing. If the sun gear is connected with the ring gear through the switching mechanism to establish the low speed stage, the transmission is rotated integrally so that the engine torque is transmitted directly. In contrast, if the sun gear is fixed with the casing to establish the high speed stage, a rotational speed of the carrier is raised to be higher than that of the ring gear by a differential action. In addition, the switching mechanism is allowed to be shifted to a neutral position where the sun gear is connected with neither the ring gear nor the casing. That is, if the switching mechanism is situated at the neutral position, the sun gear is allowed to rotate freely so that none of the speed ratio is established. On the other hand, a single-pinion type planetary gear unit is used as the power distribution mechanism. In the power distribution mechanism, a sun gear is connected with the first motor, a carrier is connected with the carrier of the transmission, and a ring gear is connected with the output shaft.

As described, the sun gear of the transmission is allowed to rotate freely under the situation that the switching mechanism is sifted to the neutral position. If the sun gear is thus allowed to rotate freely, the sun gear will not establish a reaction against a drive force delivered from the engine to the ring gear of the transmission, and the torque will be wasted by the sun gear. In this situation, even if the first motor is driven, the torque of the first motor will not be delivered to the carrier of the power distribution mechanism and the carrier of the transmission. Therefore, in the hybrid drive system taught by Japanese Patent Laid-Open No. 2011-255889, it would be difficult to start the engine by the first motor if the switching mechanism is stuck at the neutral position for some reasons.

The present invention has been conceived nothing the foregoing technical problems, and it is an object to provide a control system for a power transmission unit that allows the engine to be rotated by a motor even if any of engagement elements of a transmission is in trouble.

### DISCLOSURE OF INVENTION

The control system of the present invention is applied to a power transmission unit, in which a transmission is connected with an output shaft of an engine, and the transmission is provided with at least two engagement elements. In the transmission, the output shaft of the engine is locked by engaging both of the engagement elements, and the engine is disconnected from the transmission by disengaging both of the engagement elements. In order to achieve the above-explained object, the control system is configured to send out an alternate command for engaging one of the engagement elements while disengaging the other engagement element to bring the engine into an allowable condition to be started by the motor, in case a rotational speed of the engine cannot be raised to a predetermined speed during motoring even if sending out an initial command for disengaging said one of the engagement elements while engaging said other engagement element to bring the engine into an allowable condition to be started by the motor.

The control system is further configured not to start the engine by the motor in case the rotational speed of the engine cannot be raised to the predetermined speed during motoring even if sending out the alternate command instead of the initial command.

The power transmission unit to which the control system of the present invention is applied is comprised of an output member adapted to deliver a torque to drive wheels, and a differential mechanism adapted to distribute an engine torque to the motor and to the output member. In the power transmission unit, the transmission is interposed between the engine and the differential mechanism, a torque of the motor is delivered to the output member.

Thus, given that a rotational speed of the engine cannot be raised to the predetermined speed during motoring even if sending out the initial command for disengaging one of the engagement elements while engaging the other engagement element to connect the engine with the transmission or to unlock the output shaft of the engine, the control system of the present invention sends out the alternate command for engaging one of the engagement elements while disengaging the other engagement element to connect the engine with the transmission or to unlock the output shaft of the engine. For example, if one of the engagement elements is in a condition unable to be engaged so that both of the engagement elements are disengaged, the torque of the motor cannot be delivered to the engine through the transmission so that the rotational speed of the engine 1 cannot be raised. By contrast, if one of the engagement elements is in a condition unable to be disengaged so that both of the engagement elements are engaged, the output shaft of the engine is locked by the transmission. In those cases, the control system of the present invention sends out the alternate command to the engagement elements in a manner to connect the engine with the transmission or to unlock the output shaft of the engine. Therefore, the torque of the motor to rotate the engine is allowed to be delivered to the engine through the transmission even if one of the engagement elements cannot be engaged or disengaged. For this reason, the engine can be started certainly by the torque of the motor.

Given that both of the engagement elements are still engaged or disengaged even if the alternate signal was sent so that the rotational speed cannot be raised to the predetermined speed, the control system of the present invention ceases the starting operation of the engine. In this case, the electric energy will not be consumed by the motoring of the engine and the electric energy thus saved may be used to propel the vehicle.

As described, the control system of the present invention is applied to the power transmission unit in which the engine is connected with the motor through the transmission and the differential mechanism. In the power transmission unit thus structured, if a rotational speed of the engine cannot be raised to the predetermined speed during motoring even if sending out the above-mentioned initial command, the control system of the present invention sends out the alternate command to connect the engine with the transmission or to unlock the output shaft of the engine. Therefore, the torque of the motor can be delivered to the engine through the transmission so that the engine can be started certainly by the torque of the motor even if one of the engagement elements cannot be engaged or disengaged.

### BRIEF DESCRIPTION OF DRAWINGS

FIG. 1 is a flowchart showing one example of the control to be carried out by the control system of the present invention.

FIG. 2 is a nomographic diagram showing states of a transmission and a power distribution device under the condition that the routine shown in FIG. 1 is executed while shifting a drive mode from EV mode to HV mode and setting a low stage of the transmission.

FIG. 3 is a nomographic diagram showing states of a transmission and a power distribution device under the condition that the routine shown in FIG. 1 is executed while shifting a drive mode from EV mode to HV mode and setting a high stage of the transmission.

FIG. 4 is a skeleton diagram schematically showing one example of a powertrain of a hybrid vehicle to which the present invention is applied.

FIG. 5 is a block diagram schematically showing one example of the control system according to the present invention.

FIG. 6 is a table showing operating states of a clutch, a brake and motor-generators under each drive mode of the powertrain shown in FIG. 4.

### BEST MODE FOR CARRYING OUT THE INVENTION

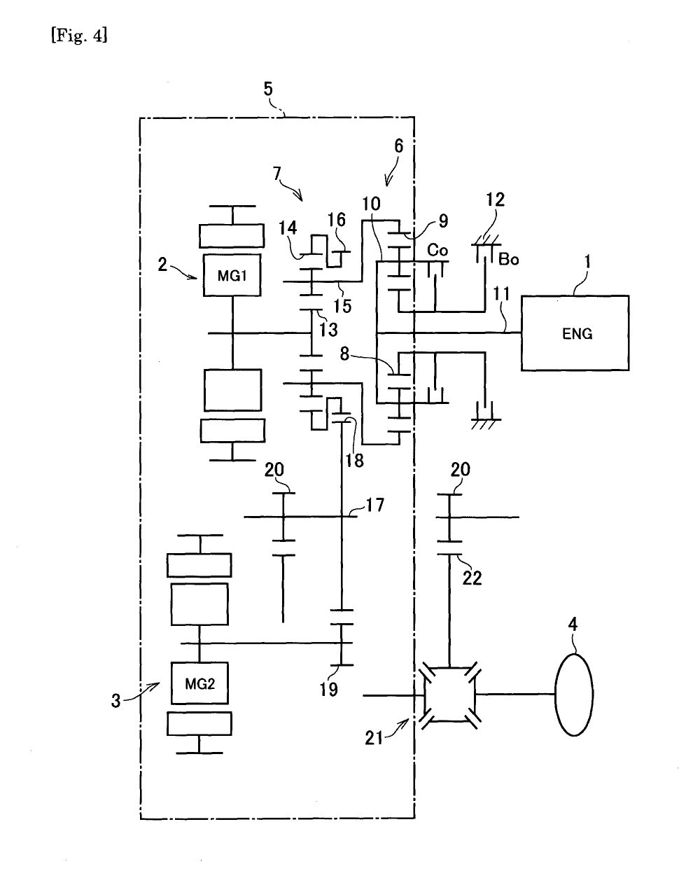

Referring now in more detail to the drawings, FIG. 4 shows a preferred example of a powertrain of the hybrid vehicle. As shown in FIG. 4, a prime mover of the hybrid vehicle is comprised of an engine (ENG) 1, and two motor-generators (MG1, MG2) 2, 3. In the preferred example, a drive force generated by the engine 1 is transmitted selectively to a power transmission mechanism 5 thereby delivering the drive force to driving wheels 4.

The power transmission mechanism 5 is comprised of a transmission 6 adapted to shift a gear stage thereof between at least a high stage and a low stage, and a power distribution device 7 that distributes the power transmitted from the engine 1 through the transmission 6 to the first motor-generator 2 side and to an output side. For example, a geared transmission, a roller-type transmission, a belt-driven transmission and so on may be used as the transmission 6, and in the example shown in FIG. 4, a single-pinion planetary gear unit is employed as the transmission 6. As the conventional single-pinion type planetary gear unit, the transmission 6 is comprised of a sun gear 8, a ring gear 9 as an internal gear arranged concentrically with the sun gear 8, a pinion gear(s) meshing with both the sun gear 8 and the ring gear 9, and a carrier 10 holding the pinion gear(s) in a manner such that the pinion gear(s) is/are allowed to rotate and revolve around the sun gear 8. The carrier 10 is connected with an output shaft 11 of the engine 1 to serve as an input member, the sun gear 8 serves as a reaction member, and the ring gear 9 serves as an output member.

A clutch C0 is arranged to selectively connect the sun gear 8 with the carrier 10, and a brake B0 is arranged to selectively halt the sun gear 8 by connecting the sun gear 8 with a predetermined fixing member 12 such as a casing. Thus, those clutch C0 and brake B0 individually serves as the engagement mechanism of the present invention, and to this end, a hydraulic frictional engagement device, an electromagnetic frictional engagement device, a dog clutch etc., may be used as the clutch C0 and brake B0. In the example show in FIG. 4, specifically, a hydraulic frictional engagement device is individually used as the clutch C0 and brake B0. Therefore, the sun gear 8 is connected with the carrier 10 to be rotated integrally by engaging the clutch C0, and consequently, the transmission 6 is rotated entirely integrally. By contrast, the sun gear 8 is halted by engaging the brake B0, and in this situation, the carrier 10 is rotated so that the ring gear 9 is rotated at a speed faster than that of the carrier 10. That is, in the transmission 6, a direct stage (i.e., a low stage) is established by engaging the clutch C0, and a high stage where a speed ratio is smaller than that of the direct stage is established by engaging the brake B0. Given that both of the clutch C0 and the brake B0 are disengaged, the sun gear 8 is allowed to be rotated freely. In this case, therefore, the drive force of the engine 1 is transmitted to the carrier 10 but it will not be transmitted to the power transmission mechanism 5 due to a torque drop of the sun, gear 8. Thus, the clutch C0 and the brake B0 are used to connect the engine 1 selectively with the power transmission mechanism 5.

A differential mechanism having three rotary elements may be used as the power distribution device 7. In the example shown in FIG. 4, specifically, a single-pinion type planetary gear unit is used as the power distribution device 7, and arranged coaxially with the engine 1. The first motor-generator 2 is arranged in the opposite side of the engine 1 across the power distribution device 7, and a sun gear 13 of the power distribution device 7 is connected with a rotor of the first motor-generator 2. In the power distribution device 7, a ring gear 14 is arranged concentrically with the sun gear 13, and a pinion gear(s) interposed between the sun gear 13 and the ring gear 14 while meshing therewith is/are supported by a carrier 15 while being allowed to rotate and revolve around the sun gear 13. The carrier 15 is connected with the ring gear 9 serving as an output member of the transmission 6, and the ring gear 14 is connected with a drive gear 16 disposed between the transmission 6 and the power distribution device 7.

A countershaft 17 is arranged in parallel with a common rotational center axis of the power distribution device 7 and the first motor-generator 2, and a counter driven gear 18 meshing with the drive gear 16 is fitted onto the countershaft 17 to be rotated integrally therewith. A diameter of the counter driven gear 18 is larger than that of the drive gear 16 so that a rotational speed is reduced, that is, a torque is amplified during transmitting the torque from the power distribution device 7 to the countershaft 17.

The second motor-generator 3 is arranged in parallel with the countershaft 17 so that torque thereof can be added to the torque transmitted from the power distribution device 7 to the driving wheels 4. To this end, a reduction gear 19 connected with a rotor of the second motor-generator 3 is meshed with the counter driven gear 18. A diameter of the reduction gear 19 is smaller than that of the counter driven gear 18 so that the torque of the second motor-generator 3 is transmitted to the counter driven gear 18 or the countershaft 17 while being amplified.

In addition, a counter drive gear 20 is fitted onto the countershaft 17 in a manner to be rotated integrally therewith, and the counter drive gear 20 is meshed with a ring gear 22 of a differential gear unit 21 serving as a final reduction device. Note that a position of the differential gear unit 21 is displaced to the right side in FIG. 4 for the convenience of illustration.

In the powertrain shown in FIG. 4, each motor-generators 2 and 3 is connected individually with an electric storage device such as a battery through a not shown controller such as an inverter. Therefore, the motor-generators 2 and 3 are individually switched between a motor and a generator by controlling a current applied thereto. Meanwhile, an ignition timing of the engine 1 and an opening degree of the throttle valve are controlled electrically, and the engine 1 is stopped and restarted automatically.

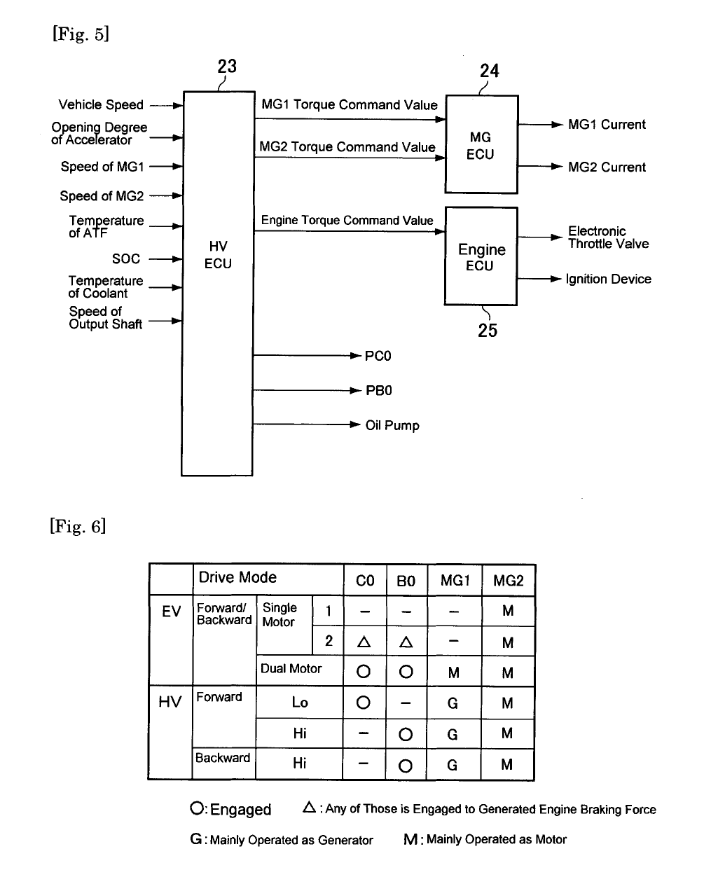

Those controls are executed by an electronic control unit, and a control system of the preferred example is shown in FIG. 5. The control system is comprised of a hybrid control unit (as will be called HV-ECU hereinafter) 23 for controlling the vehicle entirely, a motor-generator control unit (as will be called MG-ECU hereinafter) 24 for controlling the motor-generators 2 and 3, and an engine control unit (as will be called E/G-ECU hereinafter) 25 for controlling the engine 1. Each control unit 23, 24 and 25 are individually composed mainly of a microcomputer configured to carry out a calculation based on input data and preinstalled data, and to output a calculation result in the form of a command signal. For example, a vehicle speed, an opening degree of an accelerator, a speed of the first motor-generator 2, a speed of the second motor-generator 3, a temperature of the oil (i.e., ATF), a state of charge (abbreviated as “SOC” hereinafter) of the battery, a temperature of coolant of the engine 1, a speed of the engine 1, and so on are inputted to the HV-ECU 23. Meanwhile, the HV-ECU 24 is configured to output a torque command for the first motor-generator 2, a torque command for the second motor-generator 3, a torque command for the engine 1, a hydraulic command PC0 for the clutch C0, a hydraulic command PB0 for a brake B0, a command for a no shown oil pump and so on.

The torque command for the first motor-generator 2 and the torque command for the second motor-generator 3 are sent to the MG-ECU 24, and the MG-ECU 24 calculates current commands to be sent individually to the first motor-generator 2 and the second motor-generator 3 using those input data. Meanwhile, the torque command for the engine 1 is sent to the E/G-ECU 25, and the E/G-ECU 25 calculates a command to control an opening degree of a throttle valve and a command to control an ignition timing using those input data, and the calculated commands are individually sent to an electronic throttle valve and ignition device (not shown).

In the hybrid vehicle thus structured, a drive mode can be selected from a plurality of drive modes. The drive mode of the hybrid vehicle may be categorized generally into hybrid mode (abbreviated as “HV mode” hereinafter) and motor mode (abbreviated as “EV mode” hereinafter). Basically, under the HV mode, the engine 1 is driven and the power of the engine 1 is distributed to the first motor-generator 2 side and to the output side. The power distributed to the first motor-generator 2 is converted into an electric power by the first motor-generator 2 and delivered to the second motor-generator 3. Then, the electric power delivered to the second motor-generator 3 is converted into a mechanical power again by the second motor-generator 3 to be delivered to the driving wheels 4. By contrast, under the EV mode, the engine 1 is stopped and the vehicle is powered by any of the motor-generators 2 and 3.

Under the HV mode, the engine 1 is connected with the power transmission mechanism 5 by engaging the clutch C0 or the brake B0. Operating states of the clutch C0 and the brake B0 under the HV mode are shown in FIG. 6. Under the HV mode, specifically, the gear stage of the transmission 6 can be selected from the low stage (Low) or the high stage (Hi) to propel the vehicle in the forward direction. In both cases, the first motor-generator 2 is operated as a generator, and the second motor-generator 3 is operated as a motor. Additionally, when propelling the vehicle backwardly, the brake B0 is engaged and the high stage is selected in the transmission 6. In this situation, the first motor-generator 2 is also operated as a generator, and the second motor-generator 3 is also operated as a motor.

As described, if the brake B0 is engaged, the sun gear 8 is halted so that the high stage is established. Under the high stage, the ring gear 9 as the output member of the transmission 6 is rotated at a speed higher than that of the engine 1, and the carrier 15 as the input member of the power distribution device 7 is rotated at a same speed as the ring gear 9. In this situation, if the first motor-generator 2 is operated as a generator to apply a torque to the sun gear 13 in a direction opposite to a torque acting on the carrier 15, a torque is applied to the ring gear 14 as the output member and the drive gear 16 integrated therewith while being amplified according to a gear ratio of the power distribution device 7. The torque thus amplified is further transmitted to the countershaft 17. An electric power generated by the first motor-generator 2 is delivered to operate the second motor-generator 3 as a motor, and a torque of the second motor-generator 3 is also transmitted to the countershaft 17. In addition, given that the rotational speed of the first motor-generator 2 is zero, the power of the engine 1 is transmitted entirely to the driving wheels 4 only by a mechanical means without being converted into an electric power on the way. Such operating condition may be called a “mechanical point” where power transmission efficiency is enhanced.

By contrast, if the clutch C0 is engaged instead of the brake B0, the sun gear 8 is connected with the carrier 10 thereby establishing the low stage. Under the low stage, the ring gear 9 is rotated at the same speed as the engine 1, and the carrier 15 of the power distribution device 7 is rotated at the same speed as the ring gear 9. In this situation, if the rotational speed of the first motor-generator 2 is reduced to zero, the power of the engine 1 is also transmitted entirely to the driving wheels 4 only by a mechanical means without being converted into an electric power on the way. That is, in the powertrain of the preferred example, the above-explained mechanical point at which the power transmission efficiency is enhanced can be realized not only under the high stage but also under the low stage.

Under the EV mode, the drive mode may be selected from a “single-motor mode” where the vehicle powered only by the second motor-generator 3, and a “dual-motor mode” where the vehicle is powered by both of the first and the second motor-generators 2 and 3. To this end, the engine 1 may not be kept connected to the power transmission mechanism 5 but also be disconnected from the power transmission mechanism 5. Here, definition of the term “connected” is a condition where the torque can be transmitted between the engine 1 and the power transmission mechanism 5, and definition of term “disconnected” is a condition where the torque cannot be transmitted between the engine 1 and the power transmission mechanism 5. That is, under the single-motor mode, the drive mode may be selected from a first single-motor mode where both of the clutch C0 and the brake B0 are disengaged represented as “1” in FIG. 6, and a second single-motor mode where at least any of the clutch C0 and the brake B0 is engaged represented as “2” in FIG. 6.

Provided that both of the clutch C0 and the brake B0 are disengaged under the first single-motor mode, the sun gear 8 of the transmission 6 is allowed to rotate freely, that is, a reaction force will not be established. Therefore, even if the first motor-generator 2 is driven, a torque of the first motor-generator 2 will not be applied to the ring gear 14 and the drive gear 16 integrated therewith. That is, the torque is wasted by the sun gear 8 so that the vehicle is powered only by the second motor-generator 3. In this case, the first motor-generator 2 may be idled. Alternatively, a rotational speed of the first motor-generator 2 may be reduced to a predetermined speed, e.g., to zero. To this end, for example, the rotational speed of the first motor-generator 2 may be reduced utilizing a cogging torque. Alternatively, a rotation of the first motor-generator 2 may be stopped by supplying a current to the first motor-generator 2 (i.e., by a d-shaft locking control). Provided that the vehicle is propelled in the forward direction under the first single-motor mode, a braking force can be established by engaging any one of the clutch C0 and the brake B0.

Under the EV mode, the second single-motor mode is established by engaging at least any one of the clutch C0 and the brake B0, and the dual-motor mode is established by engaging both of the clutch C0 and the brake B0. Under the dual-motor mode, both of the first and the second motor-generators 2 and 3 are operated as motors. In this situation, the sun gear 8 is connected with the carrier 10 to integrate the transmission 6, while being fixed by the brake B0. Therefore, the transmission 6 is fixed entirely, and a rotation of the engine 1 is stopped by the transmission thus fixed.

Meanwhile, the carrier 15 of the power distribution device 7 is fixed together with the ring gear 6 of the transmission 6. In this situation, the power distribution device 7 as a planetary gear unit is allowed to serve as a transmission to change the speed according to a gear ratio thereof, by rotating the first motor-generator 2 in a direction opposite to the rotational direction of the ring gear 14 of the case that the vehicle is driven in the forward direction. Consequently, the torque of the first motor-generator 2 is changed according to the speed ratio established by the power distribution device 7 while being reversed in its rotational direction, and applied to the ring gear 14. The torque of the first motor-generator 2 thus changed while being reversed and the torque of the second motor-generator 3 are transmitted to the countershaft 17, and further delivered to the driving wheels 4. Those actions will not be changed even under a reverse running. Specifically, when the vehicle is driven in a backward direction, the rotational directions of the first and the second motor-generators 2 and 3 are reversed from those under the forward running.

If a small drive force that can be achieved only by the second motor-generator 3 is required, the first motor-generator 2 is not necessarily to be controlled and rotated passively.

Next, here will be explained a case of establishing the second single-motor mode by engaging only the brake B0. In this case, the first motor-generator 2 is controlled in a manner such that the sun gear 13 of the power distribution device 7 is reduced to zero, and the ring gear 14 is rotated by the torque of the second motor-generator 3 in the forward direction. Consequently, the carrier 15 is rotated at the speed lower than that of the ring gear 14. In this situation, in the transmission 6, the ring gear 9 connected with the carrier 15 to be rotated integrally is also rotated in the forward direction, and the sun gear 8 is halted by the brake B0. Therefore, the carrier 10 and the engine 1 connected thereto are rotated at a speed lower than that of the ring gear 9. That is, the high stage is established by the transmission 6, and the engine 1 is rotated passively. Alternatively, the second single-motor mode may also be achieved by engaging the clutch C0 instead of the brake B0. In this case, the low stage (i.e., the direct stage) is established by the transmission 6 so that the transmission 6 is rotated integrally. In this situation, therefore, the engine 1 is also rotated passively.

Thus, the single-motor mode and the dual-motor mode may be selected under the EV mode, and the engine 1 being stopped may be connected selectively with the power transmission mechanism 5. Those drive modes and engagement states are selected in an optimally fuel and electric efficient manner while achieving the required drive force. For example, provided that the accelerator is opened widely to require a large drive force, the dual-motor mode is selected. By contrast, provided that a small drive force is required, the single-motor mode is selected. Under the single-motor mode, when the engine braking force is required, any of the clutch C0 and the brake B0 is engaged. In contrast, when it is necessary to reduce the power loss, both of the clutch C0 and the brake B0 are disengaged to disconnect the engine 1 from the power transmission mechanism 5.

The drive mode is shifted between the EV mode and the HV mode depending on a drive demand such as an opening degree of an accelerator, a vehicle speed, an SOC of the battery and so on. For example, if the drive demand or the vehicle speed is increased or if the SOC of the battery is low under the EV mode, the drive mode is shifted to the HV mode by engaging any one of the clutch C0 and the brake B0. Consequently, the engine 1 is connected with the power transmission mechanism 5 and started to deliver the torque thereto. In the above-explained hybrid vehicle, the engine 1 is started by the first motor-generator 2. That is, during motoring of the engine 1, the engine 1 is driven by an external force such as a torque of the first motor generator 2 until the engine 1 is brought into a self-sustaining condition. Such starting operation of the engine may also be called a “cranking”. In addition, during the motoring of the engine 1 under the EV mode, a speed ratio of the transmission 6 is changed depending on a vehicle speed. Therefore, the engine speed will not be raised excessively after the completion of the motoring of the engine 1, that is, after shifting to the HV mode so that the power loss will not be increased.

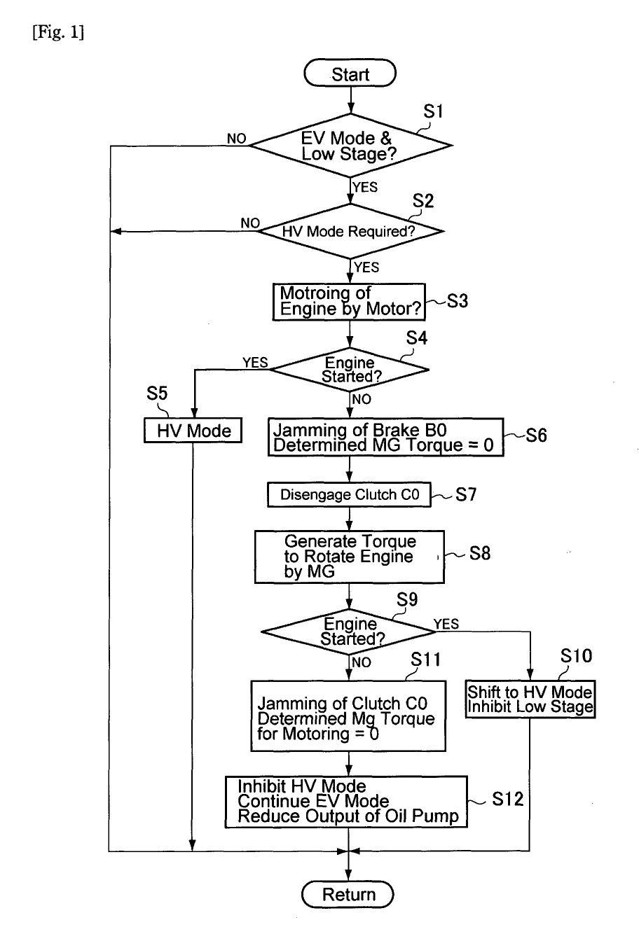

The control system of the present invention is configured to control the clutch C0 and the brake B0 during the shifting operation of the drive mode from the EV mode to the HV mode. Hereinafter, a preferred control example will be explained with reference to FIG. 1, and the HV-ECU 24 is configured to repeat the routine shown therein at predetermined short intervals.

According to the control example shown in FIG. 1, first of all, it is determined whether or not the vehicle is driven under the EV mode and the low stage of the transmission 6 (at step S1). As described, the low stage of the transmission 6 is established by engaging the clutch C0 while disengaging the brake B0. Therefore, the low stage can be determined based on a hydraulic command PC0 for engaging the clutch C0 and a hydraulic command PB0 for disengaging the brake B0. As also described, the EV mode is selected under the situation where a large drive force is not required and the SOC of the battery is sufficient. Accordingly, the EV mode may be determined based on the drive demand and the SOC of the battery. Alternatively, the EV mode may also be determined based on a torque command for the engine 1 and an opening command for the electric throttle valve.

If the low stage is not established in the transmission 6, or if the vehicle is not driven under the EV mode so that the answer of step S1 is NO, the routine is returned without carrying out any specific control. By contrast, if the vehicle is driven under the EV mode and the low stage is established by the transmission 6 so that the answer of step S1 is YES, it is determined whether or not the drive mode is required to be shifted to the HV mode (at step S2). For example, the determination of step S2 can be made based on a fact that the required drive force cannot not be achieved under the EV mode, and a fact that an electric consumption is increased by auxiliaries so that the SOC is lowered. That is, at step S2, it is determined whether or not a condition to restart the engine 1 is satisfied. Alternatively, the determination of step S2 may also be made based on a transmission of a command for motoring the engine 1. If the drive mode is not required to be shifted to the HV mode so that the answer of step S2 is NO, the routine is returned without carrying out any specific control.

By contrast, if the drive mode is required to be shifted to the HV mode by restarting the engine 1 so that the answer of step S2 is YES, the engine 1 is rotated by a torque of the first motor-generator 2 (at step S3). If the drive torque is changed by the torque of the first motor-generator 2 during motoring of the engine 1, such change in the drive torque is adjusted by changing an output torque of the second motor-generator 3. To this end, changes in the output torques of the first and the second motor-generators are preinstalled in accordance with a displacement and a temperature of the engine 1, a vehicle speed, a time required to start the engine 1 and so on. Alternatively, the output torques of the motor-generators may also be individually calculated using a motion equation of the vehicle.

During or after motoring the engine 1 at step S3, it is determined whether or not the engine 1 has been started (at step S4). Given that a gasoline engine is used as the engine 1, a fuel supply to the engine 1 is started while energizing an ignition plug when a rotational speed thereof is raised to an ignition speed. Consequently, the fuel is burnt so that a self-sustaining condition of the engine 1 is achieved. Accordingly, if the engine speed has not yet reached a predetermined target speed such as the ignition speed or the self-sustaining speed even after a lapse of predetermined period of time from a commencement of the motoring of the engine 1, it can be concluded that the motoring of the engine 1 was unsuccessful. By contrast, if the engine speed is higher than the target speed, the control system determines that the engine 1 has already been started so that the answer of step S4 will be YES. In this case, the drive mode is shifted to the HV mode (at step S5), and the routine is then returned.

As described, if the engine speed is still lower than the target speed during the motoring, the control system determines that the engine 1 has not yet been started so that the answer of step S4 will be NO. In this case, such failure in starting of the engine 1 can be attributed to a jamming of the brake B0 while being engaged. Therefore, the torques of the first and the second motor-generators 2 and 3 used to rotate the engine 1 are reduced to zero (at step S6). For example, if the clutch C0 in a normal condition is engaged and the brake B0 becomes jammed while being engaged, the sun gear 8 of the transmission 6 is connected with the carrier 10 so that the transmission 6 is brought into a condition to be rotated integrally. In this situation, since the sun gear 8 is halted by the brake B0, the transmission 6 is locked or tied up entirely thereby stopping a rotation of the engine 1. Therefore, it is difficult to start the engine 1 by rotating by the torque of the first and the second motor-generators 2 and 3.

During or after reducing the torques of the motor-generators 2 and 3 at step S6, the hydraulic command PC0 for disengaging the clutch C0 is transmitted (at step S7). As described, the brake B0 becomes jammed while being engaged in this situation. Therefore, the high stage is established in the transmission 6 by disengaging the clutch C0. As a result of disengaging the clutch C0, the transmission 6 being locked is unlocked so that the engine 1 is connected with the power transmission mechanism 5 thereby allowing a torque transmission therebetween.

During or after transmitting the hydraulic command PC0 for disengaging the clutch C0, the torque of the first motor-generator 2 and the second motor-generator 3 are raised to rotate the engine 1 (at step S8). Then, as the step S4, it is determined whether or not the engine 1 has been started (at step S9).

If the engine speed is raised to be higher than the target speed, the control system determines that the engine 1 has been started so that the answer of step S9 will be YES, and the drive mode is shifted to the HV mode. In this case, since the jamming of the brake B0 was determined at step S6, the gear stage is inhibited to be shifted to the low stage, and the routine is returned (at step S10).

By contrast, if the engine speed is still lower than the target speed, the control system determines that the engine 1 has not yet been started so that the answer of step S9 will be NO. In this case, the clutch C0 is also deemed as becoming jammed while being engaged. Therefore, the torques of the first and the second motor-generators 2 and 3 used to rotate the engine 1 are reduced to zero (at step S11). That is, at step S6, the control system determines a fact that the transmission 6 is locked.

Then, since the transmission 6 is thus locked, the drive mode is inhibited to be shifted to the HV mode, and the EV mode is continued to propel the vehicle. In addition, a discharging pressure of an electric oil pump is reduced (at step S12). In this situation, since both of the brake B0 and the clutch C0 become jammed while being engaged, it is not necessary for the oil pump to establish hydraulic pressures for engaging those elements. Therefore, the electric energy consumed to drive the electric oil pump can be reduced thereby saving the electric energy stored in the battery. Then, the routine shown in FIG. 1 is returned.

FIG. 2 is a nomographic diagram showing states of the transmission 6 and the power distribution device 7 under the condition that the routine shown in FIG. 1 is executed while shifting the drive mode from EV mode to HV mode and setting the low stage of the transmission 6. In order to establish the low stage, the hydraulic command PC0 for engaging the clutch C0 is transmitted to the clutch C0, and the hydraulic command PB0 for disengaging the brake B0 is transmitted to the brake B0. If both of the clutch C0 and the brake B0 are in normal condition, consequently, the clutch C0 is engaged and the brake B0 is disengaged to establish the low stage as indicated by a thin dashed line in FIG. 2. In this situation, the engine 1 is allowed to be rotated and started by the first motor-generator 2. However, if the brake B0 becomes jammed while being engaged, both of the clutch C0 and the brake B0 will be engaged during the process of establishing the low stage. In this case, the transmission 6 will be locked as indicated by a solid line in FIG. 2. Consequently, the carrier 15 of the power distribution device 7 is fixed so that the rotation thereof is reduced to zero. Therefore, it is difficult to rotate the engine 1 by the first motor-generator 2.

In this case, therefore, the high stage is established instead of the low stage. That is, the high stage can be established by disengaging the clutch C0 even if the brake B0 becomes jammed while being engaged as indicated by a thick dashed line in FIG. 2. Therefore, the engine 1 is allowed to be started by the first motor-generator 2 under the high stage. However, if the high stage cannot be established in this situation even if transmitting the hydraulic command PC0 for disengaging the clutch C0, the control system determines that the clutch C0 also becomes jammed while being engaged. That is, the control system determines that the transmission 6 is locked. In this case, shifting of the gear stage to the HV mode is inhibited, and the EV mode is continued. In addition, the oil pump is stopped or a discharging pressure of the oil pump is reduced.

In turn, here will be briefly explained a case in which both of the clutch C0 and the brake B0 become jammed while being disengaged. As described, in order to establish the low stage, the hydraulic command PC0 for engaging the clutch C0 is transmitted to the clutch C0, and the hydraulic command PB0 for disengaging the brake B0 is transmitted to the brake B0. For example, if the clutch C0 becomes jammed while being disengaged but the brake B0 is in normal condition, both of the clutch C0 and the brake B0 are disengaged during the process of establishing the low stage. In this case, the sun gear 8 is allowed to rotate freely and cannot serve as a reaction element. In addition, the engine 1 is disconnected from the power transmission mechanism 5. In this situation, therefore, it is difficult to rotate the engine 1 by the torque of the first motor-generator 2. However, if the brake B0 is in normal condition, the high stage can be established instead of the low stage by engaging the brake B0 so that the engine 1 is allowed to be rotated and started by the first motor-generator 2 under the high stage. By contrast, if the engine 1 cannot be started even if transmitting the hydraulic command PB0 for engaging the brake B0, the control system determines that the brake B0 also becomes jammed while being disengaged. As described, both of the clutch C0 and the brake B0 are disengaged in this case so that the engine 1 is disconnected from the power transmission mechanism 5. Therefore, shifting of the gear stage to the HV mode is inhibited, and the EV mode is continued. In addition, the oil pump is stopped or a discharging pressure of the oil pump is reduced.

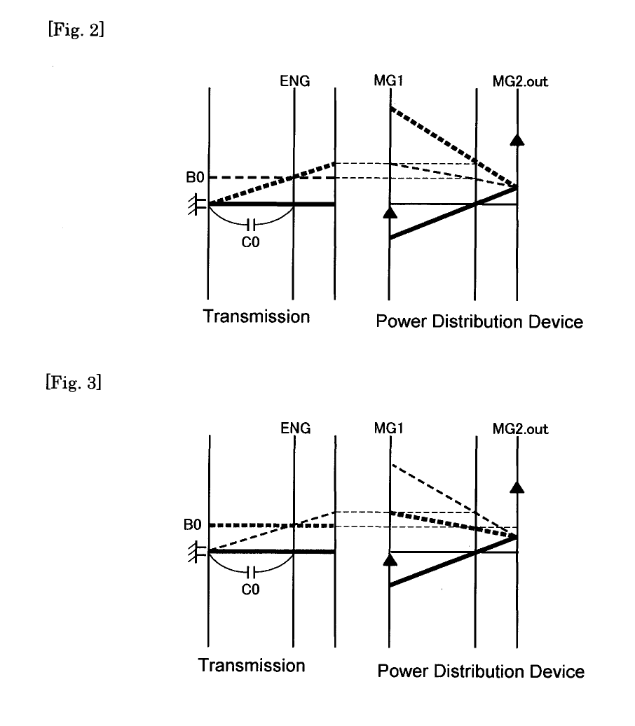

Next, here will be explained a case of carrying out the routine shown in FIG. 1 while shifting the drive mode from EV mode to HV mode under the high stage of the transmission 6. States of the transmission 6 and the power distribution device 7 of this case are shown in FIG. 3. In order to establish the high stage, the hydraulic command PC0 for disengaging the clutch C0 is transmitted to the clutch C0, and the hydraulic command PB0 for engaging the brake B0 is transmitted to the brake B0. If both of the clutch C0 and the brake B0 are in normal condition, consequently, the clutch C0 is disengaged and the brake B0 is engaged to establish the high stage as indicated by a thin dashed line in FIG. 3. In this situation, the ring gear 9 is rotated at a speed higher than that of the engine 1, and the carrier 15 of the power distribution device 7 is at a same speed as the ring gear 9. Therefore, the engine 1 is allowed to be rotated and started by the first motor-generator 2. However, if the clutch C0 becomes jammed while being engaged, both of the clutch C0 and the brake B0 will be engaged during the process of establishing the high stage. In this case, the transmission 6 will be locked as indicated by a solid line in FIG. 3. Therefore, it is difficult to rotate the engine 1 by the first motor-generator 2.

In this case, therefore, the low stage is established instead of the high stage. That is, the low stage can be established by disengaging the brake B0 even if the clutch C0 becomes jammed while being engaged as indicated by a thick dashed line in FIG. 3. Therefore, the engine 1 is allowed to be started by the first motor-generator 2 under the low stage. However, if the low stage cannot be established in this situation even if transmitting the hydraulic command PB0 for disengaging the brake B0, the control system determines that the brake B0 also becomes jammed while being engaged. That is, the control system determines that the transmission 6 is locked. In this case, shifting of the gear stage to the HV mode is inhibited, and the EV mode is continued. In addition, the oil pump is stopped or a discharging pressure of the oil pump is reduced.

In turn, here will be briefly explained a case in which both of the clutch C0 and the brake B0 become jammed while being disengaged. As described, in order to establish the high stage, the hydraulic command PC0 for disengaging the clutch C0 is transmitted to the clutch C0, and the hydraulic command PB0 for engaging the brake B0 is transmitted to the brake B0. For example, if the brake B0 becomes jammed while being disengaged but the clutch C0 is in normal condition, both of the clutch C0 and the brake B0 are disengaged during the process of establishing the high stage. In this case, the engine 1 is disconnected from the power transmission mechanism 5 and therefore it is difficult to rotate the engine 1 by the torque of the first motor-generator 2. However, if the clutch C0 is in normal condition, the low stage can be established instead of the high stage by engaging the clutch C0 so that the engine 1 is allowed to be rotated and started by the first motor-generator 2 under the low stage. By contrast, if the engine 1 cannot be started even if transmitting the hydraulic command PC0 for engaging the clutch C0, the control system determines that the clutch C0 also becomes jammed while being disengaged. As described, both of the clutch C0 and the brake B0 are disengaged in this case so that the engine 1 is disconnected from the power transmission mechanism 5. Therefore, shifting of the gear stage to the HV mode is inhibited, and the EV mode is continued. In addition, the oil pump is stopped or a discharging pressure of the oil pump is reduced.

Thus, the control system of the present invention is configured to select the high stage of the transmission 6 instead of the low stage if the drive mode cannot be shifted from the EV mode to the HV mode under the low stage. To this end, specifically, the hydraulic command PC0 for disengaging the clutch C0 is transmitted to the clutch C0, and the hydraulic command PB0 for engaging the brake B0 is transmitted to the brake B0, instead of the hydraulic command PC0 for engaging the clutch C0 and the hydraulic command PB0 for disengaging the brake B0. As a result, the engine 1 can be connected with the power transmission mechanism 5 to transmit the torque therrebetween so that the engine 1 is allowed to be rotated and started by the first motor-generator 2.

That is, according to the present invention, the drive mode can be shifted from the EV mode to the HV mode even if any one of the engagement elements is in trouble. Therefore, the battery can be charged by operating the first motor-generator 2 as a generator under the HV mode. For this reason, an over discharging of the battery will not be caused by undesirable continuity of the EV mode so that the vehicle is allowed to run without stopping. In addition, deterioration of the battery due to over discharging may also be prevented. Moreover, if the engine 1 cannot be rotated under the EV mode due to trouble of the engagement element, shifting of the drive mode to the HV mode is inhibited. In this case, the oil pump establishing engagement pressure for the engagement element is stopped, or a discharging pressure of the oil pump is reduced. Therefore, the electric energy of the battery can be saves so that the vehicle is allowed to run longer distance.

The control system of the present invention may also be applied to a vehicle having a starter motor for starting the engine. If any of the engagement elements becomes jammed in the vehicle of this kind, the transmission is also locked. In this situation, an output shaft of the engine cannot be rotated, or an inertial mass of the output shaft is increased. Consequently, a load on the starter motor to rotate the engine is increased. In this case, the control system transmits command signals to change engagement states of the engagement elements in a manner to unlock the transmission. As a result, the engine is allowed to be rotated, or the inertial mass of the output shaft of the engine is reduced. Therefore, the load on the starter motor to rotate the engine is lightened so that the engine can be started by the starter motor. That is, the HV mode can be achieved so that the vehicle is allowed to run without being stopped by an over discharging of the battery.

What is claimed is:

1. A control system for a power transmission unit, in which a transmission connected with an output shaft of an engine is provided with at least two engagement elements, in which the output shaft of the engine is locked by engaging both of the engagement elements, and in which the engine is disconnected from the transmission by disengaging both of the engagement elements,
wherein the control system is configured to send out an alternate command for engaging one of the engagement elements while disengaging the other engagement element to bring the engine into an allowable condition to be started by the motor, in case a rotational speed of the engine cannot be raised to a predetermined speed during motoring even if sending out an initial command for disengaging said one of the engagement elements while engaging said other engagement element to bring the engine into an allowable condition to be started by the motor.

2. The control system for a power transmission unit as claimed in claim 1,
wherein the control system is further configured not to start the engine by the motor in case the rotational speed of the engine cannot be raised to the predetermined speed during motoring even if sending out the alternate command instead of the initial command.

3. The control system for a power transmission unit as claimed in claim 1,
wherein the power transmission unit is comprised of an output member adapted to deliver a torque to drive wheels, and a differential mechanism adapted to distribute an engine torque to the motor and to the output member;
wherein the motor is adapted to apply a torque thereof to the output member; and
wherein the transmission is interposed between the engine and the differential mechanism.
